(19) United States
(12) Patent Application Publication
(10) Pub. No.: US 2026/0328982 A1
(43) Pub. Date: Oct. 22, 2026

(54) LIGHT-GUIDING ASSEMBLY, LENS DEVICE AND ELECTRONIC APPARATUS

(71) Applicant: TRIPLE WIN TECHNOLOGY(SHENZHEN) CO.LTD., Shenzhen (CN)

(72) Inventor: KUEI-FENG PENG, New Taipei (TW)

(21) Appl. No.: 19/321,495

(22) Filed: Sep. 8, 2025

(30) Foreign Application Priority Data
Apr. 21, 2025 (CN) 202510500151.1

(51) Int. Cl. F21V 8/00; G02B 1/00

(52) U.S. Cl. CPC G02B 6/003; G02B 1/002; G02B 6/0026; G02B 6/0055

(57) ABSTRACT

A light-guiding assembly includes: a light-guiding plate configured to guide light beam and including a first surface and a second surface parallel and spaced apart from each other; a first metalens embedded in the first surface or the second surface and configured to transmit the light beam into the light-guiding plate, the first metalens including a first meta surface inside the light-guiding plate; and a second metalens embedded in the first surface or the second surface and configured to transmit the light beam out of the light-guiding plate, the second metalens including a second meta surface inside the light-guiding plate. A lens device and an electronic apparatus are also provided.

### FIELD

The subject matter herein relates to a light-guiding assembly, a lens device including the light-guiding assembly, and an electronic apparatus including the lens device.

### BACKGROUND

In conventional compact optical system designs, lens assemblies inherently face a fundamental trade-off between physical dimensions and optical performance to achieve high-quality imaging. Traditional optical systems, based on geometric optics principles, require multiple lens combinations to correct monochromatic aberrations, such as spherical aberration, coma, and astigmatism, as well as chromatic aberrations including axial and lateral chromatic aberrations. To meet high-resolution requirements, designers typically need to increase the number of lenses (e.g., 6-8 pieces) and employ high-precision aspherical lenses to optimize the light path, which directly leads to an increase in the total length of the module. Additionally, correcting field curvature requires a symmetrical lens group layout, further occupying lateral space. This expansion in volume not only limits the development of lightweight and thin devices but also incurs high manufacturing costs.

### BRIEF DESCRIPTION OF THE DRAWINGS

Implementations of the present disclosure will now be described, by way of embodiment, with reference to the attached figures, wherein:

FIG. 1 is a perspective view schematically illustrating an electronic apparatus according to an embodiment of the present disclosure.

FIG. 2 is a perspective view schematically illustrating a lens device according to an embodiment of the present disclosure.

FIG. 3 is a perspective view schematically illustrating a light-guiding assembly according to an embodiment of the present disclosure.

FIG. 4 is a cross-sectional view along line IV-IV of the light-guiding assembly shown in FIG. 3.

FIG. 5 is a perspective view schematically illustrating a metalens.

FIG. 6 is a cross-sectional view schematically illustrating a light-guiding assembly according to another embodiment of the present disclosure.

FIG. 7 is a cross-sectional view schematically illustrating a light-guiding assembly according to another embodiment of the present disclosure.

FIG. 8 is a cross-sectional view schematically illustrating a light-guiding assembly according to another embodiment of the present disclosure.

FIG. 9 is a cross-sectional view schematically illustrating a light-guiding assembly according to another embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “comprising,” when utilized, means “including, but not necessarily limited to”; it specifically indicates open-ended inclusion or membership in the so-described combination, group, series, and the like.

When a feature or element is herein referred to as being “on” another feature or element, it can be directly on the other feature or element or intervening features and/or elements may also be present. It will also be understood that, when a feature or element is referred to as being “connected”, to another feature or element, it can be directly connected, attached, or coupled to the other feature or element or an intervening features or elements may be present.

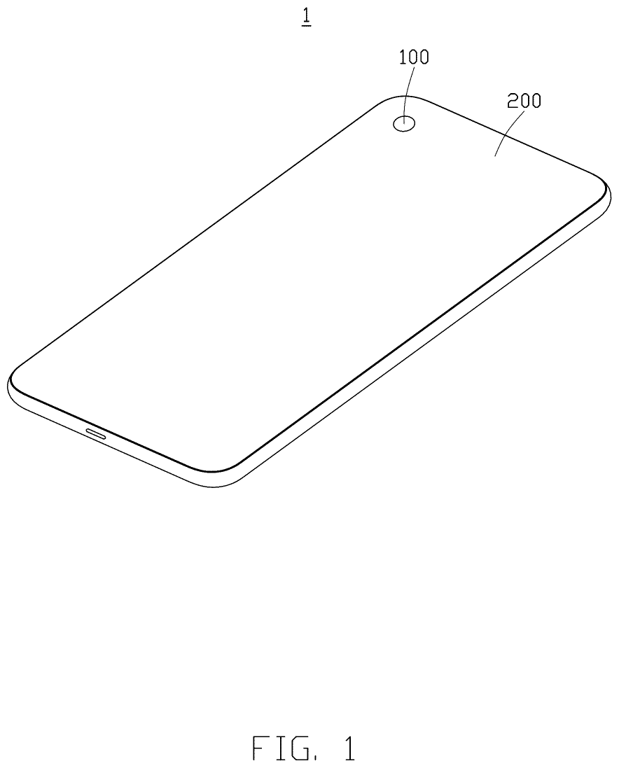

Referring to FIG. 1, an electronic apparatus 1 provided in the present embodiment includes a lens device 100 and a housing 200, wherein the lens device 100 is inside the housing 200. The electronic apparatus may be a sports camera, a mobile phone, etc.

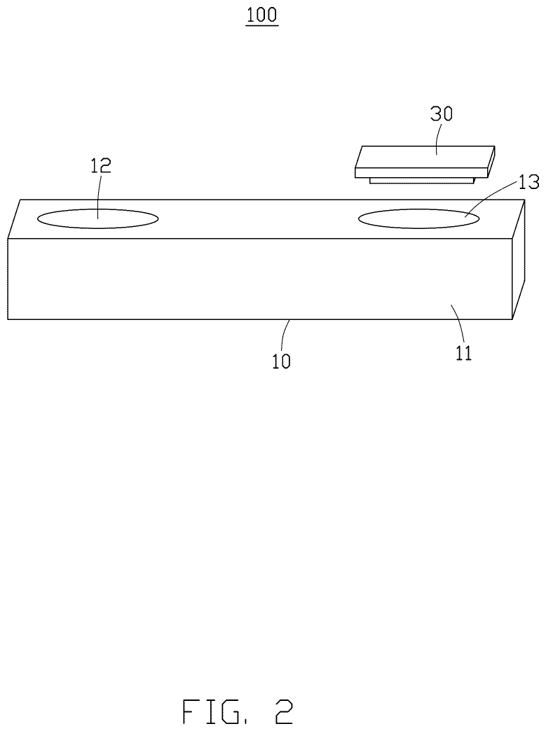

Referring to FIG. 2, the lens device 100 provided in the present embodiment includes a light-guiding assembly 10 and a light sensor 30. The light-guiding assembly 10 is used to transmit light beam and fold a light path of the light beam. The light sensor 30 is on the light path of the light beam from the light-guiding assembly 10 and is used to generate an electrical signal based on the light beam. A control device of the electronic apparatus 1 is used to receive the electrical signal and generates a corresponding image based on the electrical signal. A display panel of the electronic apparatus 1 is used to display the image. The control device may be a control chip or a control circuit board, and is electrically connected to the display panel and the light sensor 30.

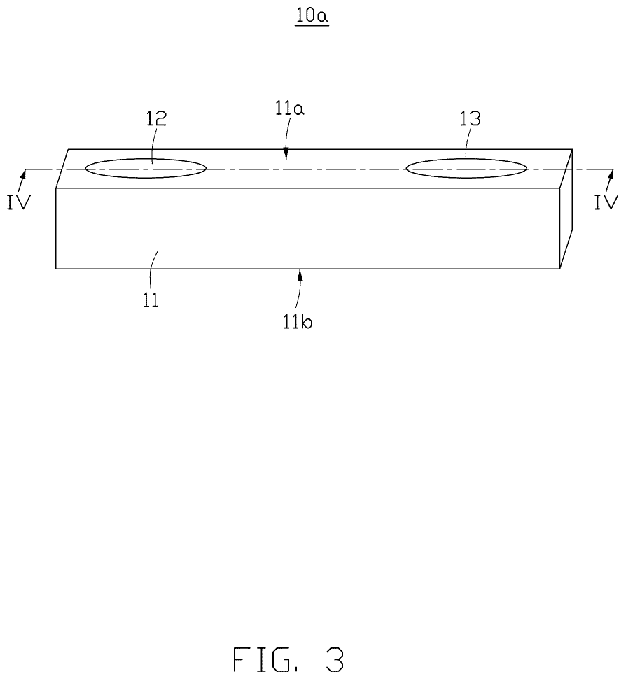

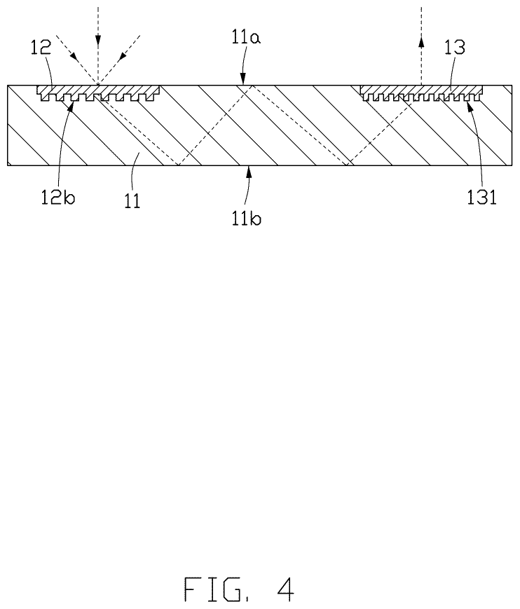

Referring to FIG. 3 and FIG. 4, a light-guiding assembly 10a provided in a first embodiment of the present disclosure includes a light-guiding plate 11, a first metalens 12, and a second metalens 13. The light-guiding plate 11 is used to transmit and guide the light beam. The light-guiding plate 11 includes a first surface 11a and a second surface 11b parallel and adjacent to each other. When the light-guiding assembly 10a is applied to the electronic apparatus 1, the first surface 11a and the second surface 11b are perpendicular to a thickness direction of the housing 200 of the electronic apparatus 1. The first surface 11a and the second surface 11b are each coated with a reflecting film for reflecting the light beam to increase a reflectivity of the light beam on the first surface 11a and the second surface 11b, which is beneficial for preventing the light beam inside the light-guiding plate 11 from passing through the first surface 11a or the second surface 11b and exiting the light-guiding plate 11. A material of the reflecting film includes gold or copper. A refractive index of the light-guiding plate 11 is greater than 1.6. In at least one embodiment of the present disclosure, the light-guiding plate 11 is a rectangular plate structure. A distance between the first surface 11a and the second surface 11b is 0.7 mm, resulting in a thin light-guiding assembly 10a, which is beneficial for reducing a volume of the lens device 100.

The first metalens 12 and the second metalens 13 are embedded in the first surface 11a and are spaced apart from each other. The first metalens 12 is used to receive and transmit the light beam into the light-guiding plate 11 to make rays in the light beam propagating along a same direction (that is, propagating in parallel). An angle of incidence of the light beam incident onto the light-guiding plate 11 is equal to or greater than a total reflection angle, so that the light beam inside the light-guiding plate 11 is alternately reflected by the first surface 11a and the second surface 11b and propagate towards the second metalens 13. The second metalens 13 is used to receive and transmit the light beam out of the light-guiding plate 11.

In other embodiments, the first metalens 12 and the second metalens 13 may embedded in the second surface 11b and are spaced apart from each other. In other embodiments, the first metalens 12 and the second metalens 13 may embedded in different surfaces of the light-guiding plate 11. That is, one of the first metalens 12 and the second metalens 13 is embedded in the first surface 11a, and the other of the first metalens 12 and the second metalens 13 is embedded in the second surface 11b.

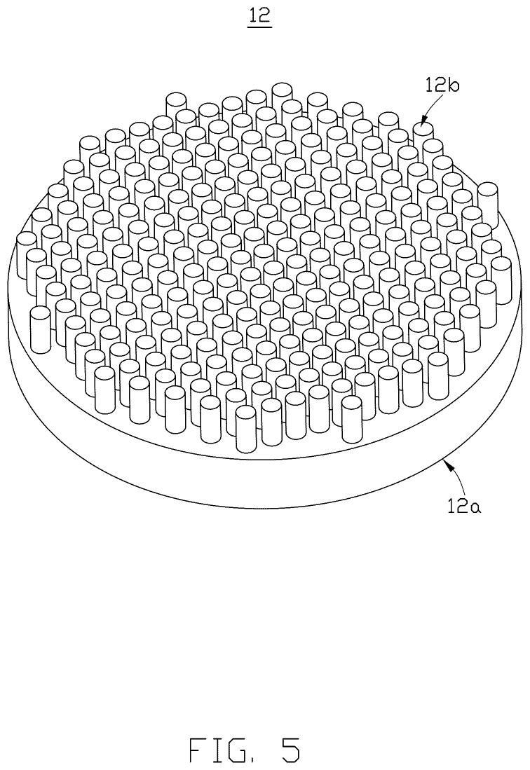

Referring to FIG. 5, the first metalens 12 includes a third surface 12a and a first meta surface 12b that are spaced apart from each other. The third surface 12a is a flat surface and is on a same plane with the surface (such as the first surface 11a shown in FIG. 4) of the light-guiding plate 11, making an appearance of the light-guiding assembly 10a smooth and beautiful. The first meta surface 12b is periodically or non-periodically provided with multiple subwavelength structural units, and the first meta surface 12b of the first metalens 12 is inside the light-guiding plate 11. Each subwavelength structural unit is used for phase modulation of the light beam to achieve functions such as focusing, imaging, polarization conversion, and multi-mode light field control of the light beam. Each subwavelength structural unit is a nanocolumn or nanosheet structure, and its geometric shape or parameters are determined based on the phase distribution that the light beam needs to achieve. The geometric parameters include heights of the subwavelength structural units, the cross-sectional areas of the subwavelength structural unit, or an angle between a side of each subwavelength structural unit and the first meta surface 12b of the first metalens 12. The subwavelength structural units are formed on the first meta surface 12b of the first metalens 12 using Nano imprint Lithography (NIL). A titanium dioxide film layer is formed on the meta surface 12b by titanium dioxide (TiO2) atomic layer deposition (ALD) technique. Titanium dioxide has high refractive index and low light absorption characteristics in the visible light band, and the titanium dioxide film layer can enhance a phase control ability of the meta surface 12b on the light beam. In at least one embodiment, each sub wavelength structural unit is a nano pillar structure with a circular cross-sectional shape and a diameter of 10 μm.

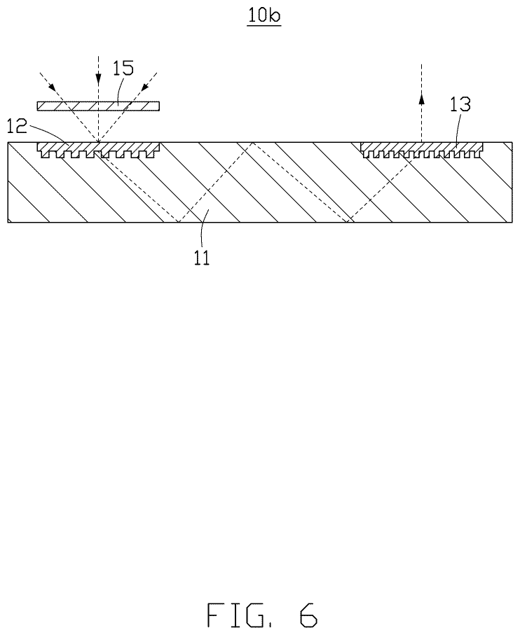

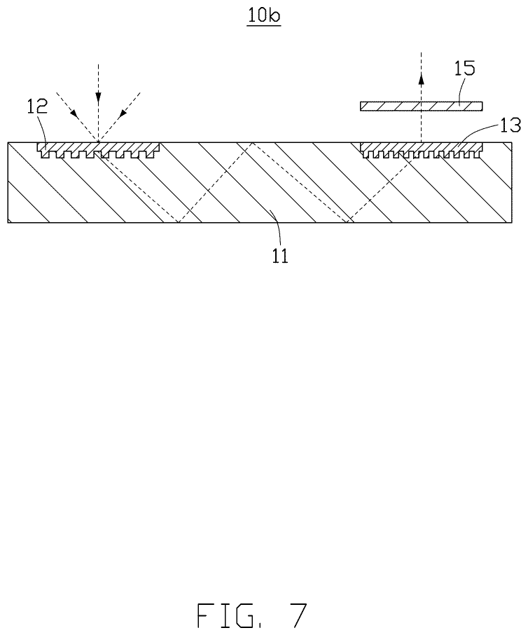

Referring to FIG. 6 and FIG. 7, in a second embodiment of the present disclosure, a difference between a light-guiding assembly 10b and the light-guiding assembly 10a is that the light-guiding assembly 10b further includes an infrared filter 15 adjacent to the light-guiding plate 11. The infrared filter is on the light path of the light beam before entering the first metalens 12 (see FIG. 6) or on the light path of the light beam transmit out of the second metalens 13 (see FIG. 7). The infrared filter 15 is used to receive the light beam and filtering out the infrared light portion in the light beam. Due to the infrared filter 15, the image generated according to the electric signal based on the light beam after removing the infrared light portion is clearer.

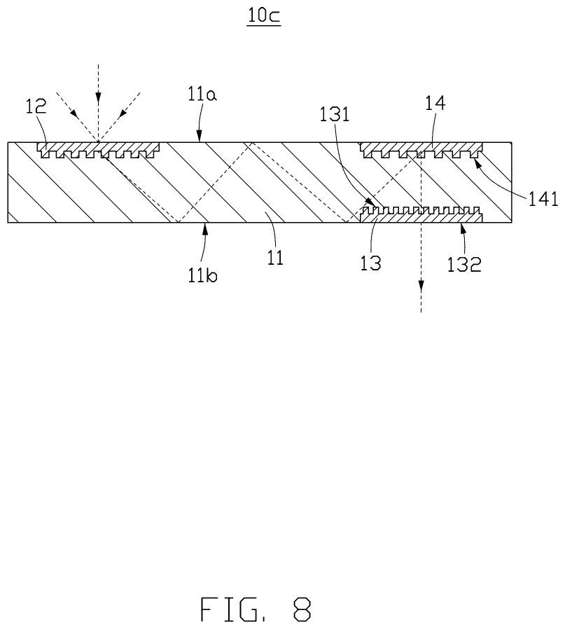

Referring to FIG. 8, in a third embodiment of the present disclosure, a difference between a light-guiding assembly 10c and the light-guiding assembly 10a is that the light-guiding assembly 10c further includes a third metalens 14. One of the third metalens 14 and the second metalens 13 is embedded in the first surface 11a and the other is embedded in the second surface 11b. The third metalens 14 includes a third meta surface 141 inside the light-guiding plate 11. The third metalens 14 is used to reflect the light beam towards the second metalens 13, so that an angle of incidence of the light beam onto the second metalens 13 is smaller than the total reflection angle. The second metalens 13 is used to filter out the infrared part of the light beam and transmit the light beam out of the light-guiding plate 11. That is, the second metalens 13 has the same function as that of the infrared filter 15.

In at least one embodiment, an incident surface (that is, a second meta surface 131) of the second metalens 13 is perpendicular to a thickness direction of the light-guiding plate 11. The third metalens 14 is used to modulate a reflection direction of the light beam, so that the light beam reflected by the third metalens 14 incidents onto the incident surface of the second metalens 13 perpendicularly, and the light beam transmit out of the second metalens 13 perpendicularly. That is, the light beam transmit out of the second metalens 13 perpendicular to an output surface 132 of the second metalens 13. When the light-guiding assembly 10c is applied to the lens device 100, a photosensitive surface of the light sensor 30 is parallel to the output surface 132 of the second metalens 13. Due to the fact that the optical path of the light beam is perpendicular to the output surface 132 of the second metalens 13, the light beam can be vertically incident on the photosensitive surface of the light sensor 30, resulting in a uniform distribution of light intensity received by the photosensitive surface of the light sensor 30, and thus making a brightness distribution of the image generated according to the electrical signal uniform.

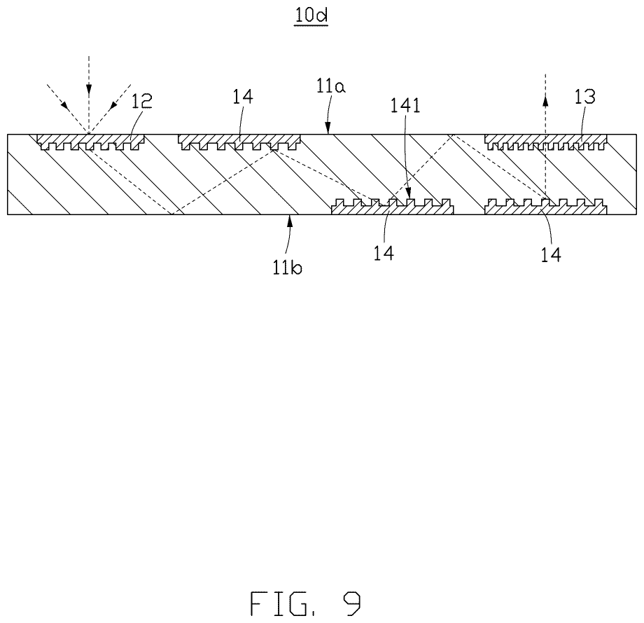

Referring to FIG. 9, in a fourth embodiment of the present disclosure, a different between a light-guiding assembly 10d and the light-guiding assembly 10c is that the light-guiding assembly 10d includes multiple third metalenses 14. Some of the third metalenses 14 are embedded in the first surface 11a, while others are embedded in the second surface 11b. Orthographic projections of the third metalenses 14 on the first surface 11a are arranged along a straight line direction and are spaced apart from each other.

FIG. 9 shows three third metalenses 14. More third metalenses 14 may be included in other embodiments. Each third metalens 14 is used to reflect the light beam. After entering the light-guiding plate 11 through the first metalens 12, the light beam is sequentially reflected by the third metalenses 14. The third metasurface 141 of each third metalens 14 is formed with the sub wavelength structural units for modulating the propagation direction of the light beam, so that after the light bema enters the light-guiding plate 11 through the first metalens 12, the incident angles when the light beam enters each third metalens 14 or the surfaces of the light-guide plate 11 remains constant, which is conducive to a stable transmission of the light beam towards the second metalens 13 in the light-guiding plate 11.

In any of the above-mentioned light-guiding assembly 10a, 10b, 10c, 10d, all metalenses (including the first metalens 12, the second metalens 13 and the third metalenses 14) have similar structures shown in FIG. 5. The meta surface of each metalens is provided with the subwavelength structural units designed according to a phase distribution requirement of the light beam, resulting in differences of patterns composed of the subwavelength structural units of different metalenses.

Each metalens and the light-guiding plate 11 includes glass, and the light-guiding plate 11 also includes thorium oxide or lanthanum oxide, resulting in a refractive index difference between the metalenses and the light-guiding plate 11. Moreover, adding thorium oxide or lanthanum oxide to the light guide plate 11 is beneficial for increasing an Abbe number of the light guide plate 11, thereby reducing a dispersion of the light beam when the light beam is propagating in the light-guiding plate 11 and improving a transmission efficiency of the light-guiding plate 11.

In the above-mentioned light-guiding assemblies 10a, 10b, 10c, 10d, the first metalens 12 is used to make the light beam enter the light-guiding plate 11 and adjust the propagation direction of the light beam, so that the light bema propagates along a preset direction inside the light-guiding plate 11, which is conducive to focusing the light beam. The light beam is alternately reflected by the surfaces of the light-guiding plate 11 and the meta surfaces of the third metalenses 14 to fold the light path. The light beam propagates towards the second metalens 13 and is finally received by the light sensor 30. That is, the light beam is transmitted to the light sensor 30 in a folded manner in the light-guiding plate 11, which is beneficial for reducing a propagation space of the light beam and thus reducing a volume of the lens device 100.

Finally, it should be noted that the above embodiments are only used to illustrate the technical solution of the present application and not to limit the present application. Although the present application has been described in detail with reference to preferred embodiments, one ordinary skill in the art should understand that the technical solution of the present application can be modified or equivalent replaced without departing from the spirit and scope of the technical solution of the present application.

What is claimed is:

1. A light-guiding assembly comprising:
a light-guiding plate configured to guide a light beam and comprising a first surface and a second surface parallel to and spaced apart from each other;
a first metalens embedded in the first surface or in the second surface, the first metalens configured to transmit the light beam into the light-guiding plate, and comprising a first meta surface inside the light-guiding plate; and
a second metalens embedded in the first surface or in the second surface, the second metalens configured to transmit the light beam out of the light-guiding plate and comprising a second meta surface inside the light-guiding plate.

2. The light-guiding assembly according to claim 1, further comprising an infrared filter configured to receive the light beam and filter out an infrared portion of the light beam;
the infrared filter is on a light path of the light beam before the light beam is guided into the first metalens; or the infrared filter is on a light path of the light beam after the light beam is transmitted out of the second metalens.

3. The light-guiding assembly according to claim 1, further comprising a third metalens, wherein one of the third metalens and the second metalens is embedded in the first surface and another one of the third metalens and the second metalens is embedded in the second surface, and the third metalens comprises a third meta surface inside the light-guiding plate; and
the third metalens is configured to reflect the light beam towards the second metalens, and the second metalens is further configured to receive the light beam from the light-guiding plate and filter out an infrared light portion in the light beam.

4. The light-guiding assembly according to claim 3, wherein the second metalens further comprises an incident surface perpendicular to a thickness direction of the light-guiding plate.

5. The light-guiding assembly according to claim 3, wherein the first metalens, the second metalens, the third metalens and the light-guiding plate are made of glass; each of the first meta surface, the second meta surface and the third meta surface is covered with a titanium dioxide film.

6. The light-guiding assembly according to claim 1, wherein each of the first surface and the second surface is coated with a reflecting film configured for reflecting the light beam.

7. The light-guiding assembly according to claim 1, wherein the light-guiding plate comprises thorium oxide or lanthanum oxide.

8. The light-guiding assembly according to claim 1, wherein an index of the light-guiding plate is greater than 1.6.

9. A lens device comprising:
a light-guiding assembly comprising:
a light-guiding plate configured to guide a light beam and comprising a first surface and a second surface parallel to and spaced apart from each other;
a first metalens embedded in the first surface or in the second surface, the first metalens configured to transmit the light beam into the light-guiding plate, and comprising a first meta surface inside the light-guiding plate; and
a second metalens embedded in the first surface or in the second surface, the second metalens configured to transmit the light beam out of the light-guiding plate, and comprising a second meta surface inside the light-guiding plate; and
a light sensor on a light path of the light beam from the light-guiding assembly and configured to generate an electrical signal according to the light beam.

10. The lens device according to claim 9, wherein the light-guiding assembly further comprises an infrared filter configured to receive the light beam and filter out an infrared portion of the light beam; and
the infrared filter is on a light path of the light beam before the light beam is guided into the first metalens; or the infrared filter is on a light path of the light beam after the light beam is transmitted out of the second metalens.

11. The lens device according to claim 9, further comprising a third metalens,
wherein one of the third metalens and the second metalens is embedded in the first surface and another one of the third metalens and the second metalens is embedded in the second surface, and the third metalens comprises a third meta surface inside the light-guiding plate; and
the third metalens is configured to reflect the light beam towards the second metalens, and the second metalens is further configured to receive the light beam from the light-guiding plate and filter out an infrared light portion in the light beam.

12. The lens device according to claim 11, wherein the second metalens further comprises an incident surface perpendicular to a thickness direction of the light-guiding plate.

13. The lens device according to claim 11, wherein the first metalens, the second metalens, the third metalens and the light-guiding plate are made of glass; each of the first meta surface, the second meta surface and the third meta surface is covered with a titanium dioxide film.

14. The lens device according to claim 9, wherein each of the first surface and the second surface is coated with a reflecting film configured for reflecting the light beam.

15. The lens device according to claim 9, wherein the light-guiding plate comprises thorium oxide or lanthanum oxide.

16. The lens device according to claim 9, wherein an index of the light-guiding plate is greater than 1.6.

17. An electronic apparatus comprising:
a housing; and
a lens device comprising:
a light-guiding assembly comprising:
a light-guiding plate configured to guide a light beam and comprising a first surface and a second surface parallel to and spaced apart from each other;
a first metalens embedded in the first surface or in the second surface, the first metalens configured to transmit the light beam into the light-guiding plate, and comprising a first meta surface inside the light-guiding plate; and
a second metalens embedded in the first surface or in the second surface, the second metalens configured to transmit the light beam out of the light-guiding plate, and comprising
a second meta surface inside the light-guiding plate; and
a light sensor on a light path of the light beam from the light-guiding assembly and configured to generate electrical signals according to the light beam.
